(19) United States
(12) Patent Application Publication
(10) Pub. No.: US 2012/0062734 A1
(43) Pub. Date: Mar. 15, 2012

(54) Coordinator Module

(76) Inventors: Sergei Y. Mironichev, Moscow (RU); Christopher D. Mechling, San Diego, CA (US)

(21) Appl. No.: 13/047,686

(22) Filed: Mar. 14, 2011

Related U.S. Application Data
(60) Provisional application No. 61/313,662, filed on Mar. 12, 2010.

(51) Int. Cl. H04N 7/18; G08C 19/16

(52) U.S. Cl. 348/143; 340/870.01; 348/E07.085

(57) ABSTRACT

A coordinator module comprising flash memory, a processor and a transceiver capable of performing a plurality of functions for a variety of electronic devices. A video server system comprising a coordinator module, a digital video camera and a cellular antenna is described herein. A remote monitoring system comprising a coordinator module, a metering instrument and a cellular antenna is also provided herein. Further described is a related method of controlling a metering instrument comprising providing a metering instrument, a coordinator module and a cellular antenna.

### PRIORITY CLAIM

This utility patent application contains subject matter claiming benefit of the priority date of U.S. Provisional Patent Application Ser. No. 61/313,662, filed on Mar. 12, 2010, entitled “Coordinator Module” and U.S. Utility patent application Ser. No. 13/009,715, filed on Jan. 19, 2011, entitled “Smart Coordinator and Video Safeguard System.” Accordingly, the entire contents of these provisional patent applications are hereby expressly incorporated by reference.

### FIELD OF THE INVENTION

The invention pertains generally to wireless communication devices and methods. More particularly, the present invention relates to a control module providing wireless connectivity and networking across a variety of digital platforms and electronic devices. In a preferred embodiment, the invention relates to a coordinator module providing wireless command and control to a variety of electronic equipment and systems thereof.

### BACKGROUND OF THE INVENTION

Recently, the digital world has seen a proliferation of new platforms, protocols and standards improving wireless broadband technology such as 4G, Long Term Evolution (LTE), 3G, Enhanced Data rates for GSM Evolution (EDGE), Global System for Mobile Communications (GSM), Code Division Multiple Access (CDMA), Worldwide Interoperability for Microwave Access (WiMax), Anfas Radio-frequency identification (RFID), ZigBee, and Bluetooth. High speed devices and increasing powerful processors are providing advanced capabilities to mobile users, for example, with the introduction of smart phones such as the iPhone having Internet and multimedia capabilities.

A variety of factors have slowed the implementation of wireless technology. One such factor is that major wireless carriers are using different networks with different communication standards and further with different frequency bands. Another factor is that wireless technology is intricate and multidisciplinary, requiring a plethora of engineering groups to make the wireless device play in a given network adhering to a given wireless standard. Hence also, electronic OEMs are likely to lack the needed wireless expertise to add this functionality since the cost of developing such technology is prohibitive. Therefore, a need remains for emerging technologies to provide consumers, military, law enforcement, mobile professionals and businesses wireless access and control of a multitude of electronic devices. Further, there remains a need providing more sharing of media and information, and additionally creating and expanding networks.

In light of the above, it is an object of the present invention to provide an electronic coordinator module having fundamental, open, backward compatible architecture, and being controlled by open source software, that provides wireless command and control to a variety of electronics equipment. It is further an object of the present invention to provide a coordinator module that can easily provide compatible wireless connectivity to a variety of consumer electronic OEMs that originally do not comprise wireless connectivity because the OEM manufactures lack wireless expertise. It is additionally an object of the present invention to provide a variety of novel applications, further providing novel systems and methods for enabling wireless command and control of electronics.

The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective illustration of a coordinator module;

FIG. 2 illustrates a perspective view of a coordinator of the present invention to be coupled to a video camera or other electronic devices;

FIG. 3 illustrates a functional block diagram of a preferred embodiment of the present invention directed to a video server system; and

FIG. 4 illustrates a functional block diagram of a preferred embodiment of the present invention directed to a remote monitoring system.

### BRIEF SUMMARY OF THE INVENTION

The present invention may be characterized as a video server system based on a coordinator module having programmable electronics including a flash memory, a processor and a transceiver. The video server system also has a digital video camera to capture video data and a cellular antenna for receiving and transmitting data via a cellular network which may be either a network based on CDMA or GSM. The coordinator module also has a video archive to retain captured video data from the digital video camera.

The digital video camera has a structure defined by a hollowed base portion for support, an upright portion defining a height of the digital video camera and a camera portion coupled to an upper end of the upright portion, all combined to form a “Z” shape in a profile of the digital video camera. The digital video camera may be activated by a motion sensor which then transmits an alert via Short Message Service (SMS), Multimedia Message Service (MMS) or e-mail to a mobile device.

A user may remotely control the coordinator module by sending an SMS message from a mobile device with an instruction to the coordinator module. The SMS message would pass over the cellular network through to the coordinator module. The coordinator module can send video data from the video archive via an MMS message to the mobile device. Additionally, the coordinator module can transmit data over low power radio frequency (RF) technology such as Bluetooth and ZigBee.

The present invention may be further characterized as a remote monitoring system having a metering instrument configured to measure a physical property as measurement data. The measurement data is then converted from an analog signal to a digital signal by an analog-to-digital converter. The metering instrument may also have a wireless transmitter to wirelessly transmit to a coordinator module. The coordinator module has a flash memory, a processor and a transceiver.

Furthermore, a user may remotely control the coordinator module by sending an SMS message from a mobile device with an instruction to the coordinator module. The SMS message would pass over the cellular network through to the coordinator module. The coordinator module may transmit an alert containing measurement data or a case scenario via SMS, MMS or e-mail to the mobile device. The coordinator module is also configured to perform trip point and calibration checks of the metering instrument and send an alert via SMS, MMS or e-mail to the mobile device.

Another aspect of the present invention may be characterized as a method of remotely controlling a metering instrument. The method is comprised of providing a metering instrument to measure a physical property as measurement data, providing a coordinator module wherein the coordinator comprises programmable electronics including a flash memory, a processor and a transceiver, wherein the metering instrument transmits measurement data to the coordinator module; and providing a cellular antenna for receiving and transmitting data via a cellular network selected from the group of CDMA and GSM. The method further provides a mobile device configured to receive and transmit data via the cellular network in a manner chosen from the group of SMS, MMS or e-mail. The coordinator module then interprets the data sent from the mobile device to perform an operation on the metering instrument such as modifying the input or output of the measured physical property.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### DESCRIPTION OF THE PREFERRED EMBODIMENTS

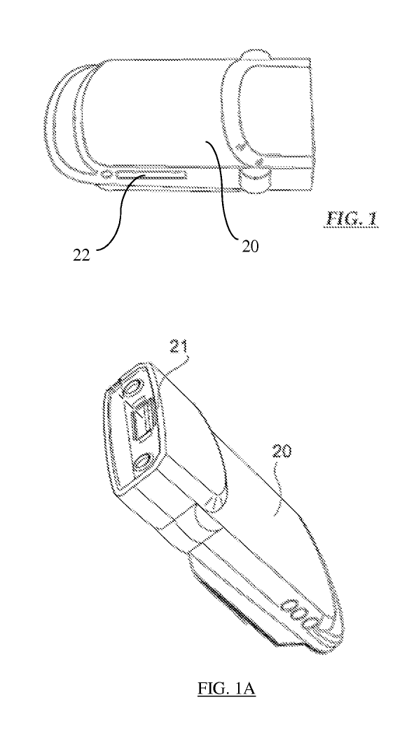

With reference to FIG. 1, a coordinator module 20 is illustrated. The coordinator module 20 has a Subscriber Identity Module (SIM) card slot 22. The coordinator module 20 has programmable electronics including a flash memory, a processor and a transceiver. The coordinator module has a USB slot 21 to allow various connections to different hardware.

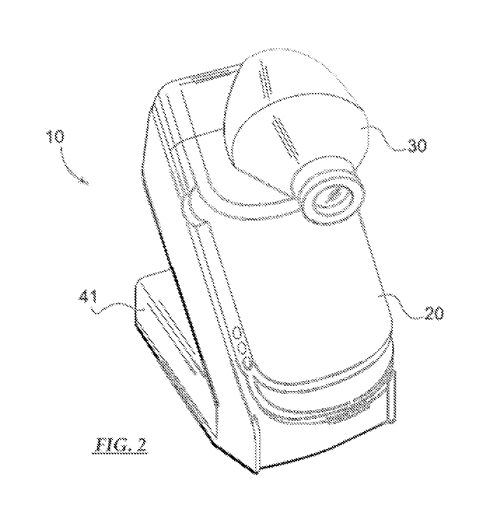

With reference to FIG. 2, a coordinator module 20 of the present invention is illustrated as coupled to a digital video camera 30 configured to capture digital image and video data. The coordinator module 20 plus the digital video camera 30 will provide the essential components to create an intelligent video surveillance system 10. Initially, the coordinator module 20 alone works like a mini-computer having a flash memory and a processor. The coordinator module 20 may be configured to have a video archive 24 to retain captured video data.

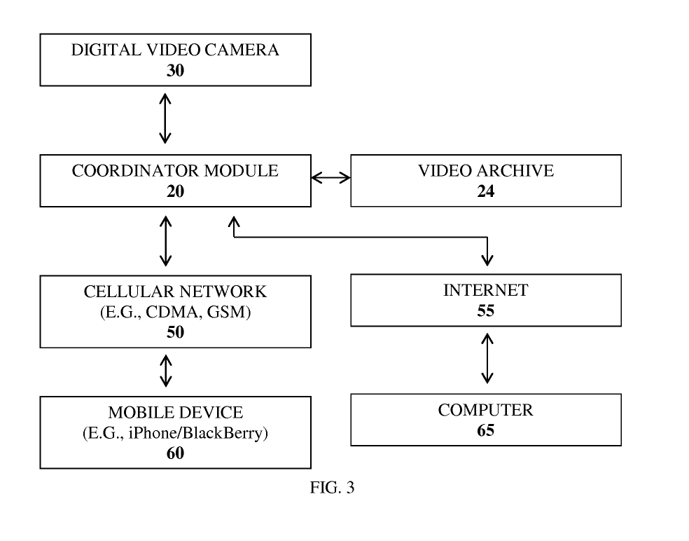

With further reference to FIG. 3, a functional block diagram directed to a video server system 100 is illustrated. The digital video camera 30 captures video data and sends the video data to the coordinator module 20. The coordinator module 20 would further comprise a video archive 24 to retain the video data. When requested by a user, the video data would pass from the video archive 24 through the coordinator module 20. The video data would then pass over a cellular network 50 through to a mobile device 60.

It further has cellular phone capabilities by having a cellular antenna to connect to a cellular network 50 such as CDMA or GSM in addition to low power, short range RF transmission capability. Hence, any modern mobile phone is able to be used to monitor and control all system features in addition to any computer with Internet access. Also according to the invention, security alerts can be given to a user having a mobile device 60 selectively in SMS, MMS, and via email. Further the system 10 employs microphones so that a user can listen to any events occurring at the scene remotely via a mobile phone or computer. The user may access the video archive 24 via SMS to request the coordinator module to send video data via MMS messaging to the mobile device 60.

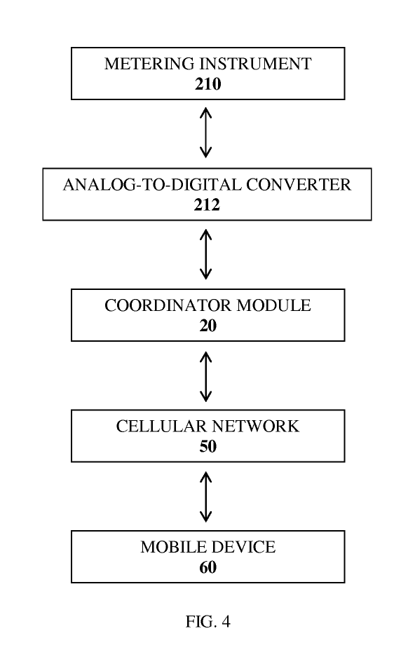

With regard to FIG. 4, in another embodiment, the invention is directed to a remote monitoring system 200 providing wireless monitoring of metering instruments 210 such as those in power plants, industrial complexes, universities, and commercial buildings, etc. In this particular embodiment, the coordinator module 20 is paired to a metering instrument 210 of the present invention. The metering instrument 210 provides the metering or sensing having an analog-to-digital converter 212 to convert measurement data from an analog signal to a digital signal and subsequently communicates data to the coordinator module. In the preferred embodiment, the metering instrument 210 can meter fluid flow without extra pipe penetrations. Also, the metering instrument 210 could plug into existing meters or sensors. Additionally, the metering instrument 210 provides inexpensive metering as compared to other solutions and designs. Examples of physical properties to be sensed are fluid flow, gas flow or pressure, hydraulic pressure, electrical parameters and the like.

The metering instrument 210 records measurement data and converts it into a digital signal with the analog-to-digital converter 212. The digital signal is then passed as digital measurement data to the coordinator module 20. When requested by a user, the digital measurement data would pass over a cellular network 50 through to a mobile device 60.

Additionally, this and other system embodiments of the present invention will included a CAN (controller area network) bus system that allows wired monitoring and control of connected components, in addition to wireless controls afforded by GSM/CDMA, satellite, WiFi, Bluetooth, and RF, etc. It is further possible to employ other means of wired control to system described herein.

Further to industrial and power plant applications, the coordinator module 20 could be employed to perform trip point and calibration checks of alarms and instrumentation. Other performance checks, maintenance and troubleshooting could also be done remotely. The coordinator module 20 of the present invention could additionally be employed remotely monitor seismographs, wave heights, in addition to iceberg and glacier movement.

It is additionally contemplated that the coordinator module 20 could be coupled to personal physiological sensors to monitor health conditions of an individual or patient. Examples of sensory information include heart rate, blood pressure, blood glucose etc.

Many additional capabilities are contemplated by the present invention such as providing wireless connectivity to motion sensors, smoke detectors, alarms and lighting systems, providing both feedback and control thereof. The system is programmable and therefore many features can be selectable and predetermined such as the periodic sending of still pictures to a mobile device via MMS or computer. This feature could also be performed ad hoc or on command.

The present invention further contemplates intelligent video motion sensing. For example, by comparing images, a digital video camera 30 could send an alert when it senses movement or alternatively turn on/off, if power consumption is a concern. Similarly, a motion sensor could be mounted to a door of a facility or other structure to either send an alert or to perform another function. In addition to real time monitoring, audio/video can be saved temporarily within the system 10 and streamed to a suitable device upon request.

In addition to commercial video surveillance systems, the coordinator module 20 herein could be used to implement a residential security system. Either application could further include smart locks that could be controlled wirelessly with a circuit coupled to an actuator that is capable of detecting an RF or an IR signal. Alternatively, the smart locks could be digitally controlled. Gates and garage doors could be controlled by mobile phone through a coordinator module to open and close. Alerts may be sent if doors or windows are ajar through sensors wirelessly coupled to a coordinator module. As stated herein, alerts may come via a coordinator module 20 to an iPhone, iPad, BlackBerry, PDA, personal computer or similar device. Because the wireless data transfer includes voice, a user could answer a ring of a doorbell through the intercom remotely. Further, the invention contemplates remote monitoring and control of your home pool, spa, digital video recorder (DVR), or other home/office equipment.

Further to receiving alerts through various channels, the surveillance/security system of the present invention is able to be controlled via SMS, email command, audio (through a mobile device) or through a computer with Internet access. For example, a user could employ an iPhone or a BlackBerry smartphone or any mobile phone compatible with SMS messaging to control a coordinator 20 of the present invention. Also, other applications are provided by linking a coordinator 20 to a computer as described herein.

The system also provides various backup and security features. Initially, all interfaces will require password protected access. Also, the system has redundant power sources and any changes to the power system will provide an alert. A separate alert is given in the event of low remaining battery power 49.

Importantly, the coordinator module 20 will also comprise a software interface to electronic devices and networks created by the present invention. Hence the coordinator module comprises a platform having hardware and software components. Both may be characterized as open architecture and open source to achieve modularity and compatibility with regard to existing and future systems. Also, the coordinator module 20 can be customized by the desired application to adhere to a desired wireless standard and comprise an appropriate chipset such as those manufactured by Intel, Broadcom and Realtek to name a few.

It is still further contemplated herein the coordinator 20 of the present invention can be paired to multiple electronic devices via its USB port 21 and mobile device technology such as CDMA and GSM. At the outset, a coordinator is paired to a personal computer at which point the proper software and drivers are installed to enable the primary interface. The invention in this embodiment further provides an online store where desired applications can be downloaded as customized by a user. One such application will expand the capabilities of the personal computer to send and receive phone calls, SMS, and MMS, in addition to sending streaming video from a webcam.

A potential problem in implementation of systems and network of the present invention that transmit data via the Internet is that a coordinator module 20 would be required to have its own IP address (not typically provide to mobile device with Internet capability). A solution provided by the present invention offers a virtual IP address for mobile/coordinator devices (cellular/satellite). This is accomplished by employing a special server to systems and networks herein as follows.

To operate with integrated WEB server, a Smart Vision/coordinator 20 heretofore would require an external public IP address. This would be an additional fee-based service of the service provider (not every operator provides such a service; for example, GSM service providers do not render this service in USA). To solve this problem, Smart Vision/coordinator module 20 of the present invention will have the new operation protocol that allows access to the device resources in any GPRS network without any additional services of the service provider. Instead, a user initially installs a small client application in an iPhone, iPad, or Smartphone.

A preferred method of providing a virtual IP address Smart Vision/coordinator module comprises the steps of: making a TCP connection with a Smart Vision server while registering in a GPRS network; authenticating the Smart Vision module using a unique identifier while registering the server; and supporting constantly the TCP connection by Smart Vision module (i.e. the device is in on-line mode that allow us to access Smart Vision resources without any delays, and in case of breaking of the Smart Vision TCP connection, it will be restored automatically, further to support constant TCP connection, a small traffic is consumed which is approximately 1 KB per day that is cheaper than the cost of the additional service of the external public IP address provision).

Usage of a SmartVision/virtual server provides the additional benefit of allowing you to keep a video archive and an event log of every Smart Vision/coordinator module for a long period of time, if necessary. This significantly expands possible variants of the device usage.

Further to the SmartVision server, there is no responsibility for transferring video or other data from the SmartVision to the user. Conversely, the server is only responsible for maintaining the virtual IP address for the mobile device. Therefore the amount of traffic handled by the server will be minimal (approximately 1 KB per user per day). It should additionally be noted that the server may provide virtual IP addresses to other types of mobile devices, not only the SmartVision. All coordinator module products may rely on such a server for Internet functions, and additionally, any mobile phone or other mobile device will be able to have a virtual IP address assigned to it through this server.

In still another preferred embodiment of the present invention, the coordinator module is configured as a SmartBridge. This particular embodiment is very useful to home and office networks in addition to various mobile applications. The SmartBridge herein comprises all the communication and connection capabilities previously discussed (GSM/CDMA, satellite, WiFi, Bluetooth, RF, USB, etc.) and contains internal, programmable memory as well as a port for removable flash memory. The basic SmartBridge further includes connections for an incoming telephone line and two outgoing lines, so it can be connected to a city telephone network, and support two telephone-type devices (such as a standard phone, speakerphone, intercom with a lock/unlock feature, FAX machine, etc.) plus an ethernet connection. Different configurations of the SmartBridge are possible for different uses. For example, additional telephone or ethernet lines can be added, or a CAN Bus could also be included, if desired.

The SmartBridge further comprises numerous functions and features including: automated call answering system (personal voicemail or office call center); interactive voice menu; call queue management (personal call waiting or office call center); automatic telephone switching center (connecting and transferring calls); a call register; call forwarding; conference call system; a VoIP system (supports SIP/H323/IAX protocols); SMS Text messaging (send/receive); MMS Picture Messaging (send/receive); e-mail messaging; standard FAX messaging and email FAX messaging; an Internet Access Point (via Ethernet or WiFi); control and monitoring of connected devices and systems (security systems, appliances, utilities, etc.); communication through wireless networks where landlines are not available; control of access to system features through password verification or ANI (Automatic Number Identification); control of system via audio menu; command and control of system via SMS message; and control of system via Internet/WiFi.

As a result, SmartBridge combines all your communication methods, (Internet, FAX, email, standard telephone, mobile telephone, VoIP, SMS and MMS), in addition to all connected devices and systems, and further makes it possible to manage all components remotely through a variety of different methods. As with other coordinator module applications, management of SmartBridge systems could be easily accomplished through a smartphone software application (such as an iPhone app).

As a more specific example of how the SmartBridge may be employed, if a user is away from home, the SmartBridge can route all incoming calls and messages to his/her mobile phone through the telephone networks. If the user's phone is WiFi compatible, then when he/she returns home, the SmartBridge can transfer calls and messages to it via WiFi. Furthermore, like the other coordinator module applications, the SmartBridge would not necessarily be limited to management through a single handset. If a call is for a user, the SmartBridge can forward the call to the user, and if a call is for the user's brother, the SmartBridge can forward the call to him.

The SmartBridge can additionally serve as a fully functional office phone system in business and commercial applications comprising an interactive voice menu, queue management, automatic call transfers, call forwarding, multiple voicemail accounts, call conferencing, etc.

The SmartBridge contains additional features that include: if a user is unavailable to answer a call, the SmartBridge will take a voicemail message and notify a user via SMS message. The user will then be able to access the specific voicemail message he/she desires to hear, either through the SmartBridge interactive audio menu. An additional feature applies to facsimile transmissions in that when a fax message is received, the SmartBridge can forward it to the user in the form of an email attachment. Still further, if a user wants to send a fax message, the SmartBridge can transmit a PDF document, a text document or an image file as a facsimile and send to wherever a user desires.

Further to the SmartBridge, if a user does not have a telephone line or a wired internet connection in a location, the SmartBridge can perform all communication functions for you through the mobile networks, creating a mobile office. Also, if long-distance telephone calls are needed, the SmartBridge can provide VoIP taking advantage of the Internet to transmit voice. This could either be accomplished by employing SmartBridge's VoIP functions when a user is locally connected via Wi-Fi or Ethernet, or a call the SmartBridge with a user's telephone/mobile phone to remotely access the VoIP system. Also, if Internet access is needed, the SmartBridge can share its internet connection with the user through WiFi or ethernet.

Yet still further to the SmartBridge embodiment of the present invention, if a user has various smart home or smart office devices or systems that they want to manage remotely, the SmartBridge can also act as the central control unit for those devices or systems.

Another application contemplated by the present invention would be to employ a coordinator module 20 to a system comprising a plurality of wireless electrical switches. The concept herein may be applicable to control of lights and/or a variety of electrical equipment. In one example, the coordinator module could be coupled to a digital controller comprising solid state electronics, or directly to each individual switches. The concept could also apply to larger switchgear.

In yet another application, the coordinator module 20 could serve as a mobile content delivery box having subscription content such as movies television. In one example, the system includes a wireless adapter connectable to a television through coaxial cable or other means for input/output signals. Additionally, a coordinator module 20 could be coupled to a hotel TV screen to use it as a computer screen further for remote control of a home computer.

In still another embodiment, the coordinator module 20 provides wireless data transfer to a geo-location system. More particularly, base stations are employed to a confined area such as a parcel of real property. Items to be tracked as part of the geo-location system are configured with a transponder able to send and receive radio signals. Triangulation methods, or other methods able to approximate and calculate bearing and range are used to locate the electronic device, which is, of course, are all trackable through the coordinator module 20 to a user's mobile device or computer.

Still further, the coordinator module 20 could be employed to a network of smoke detectors and video monitoring equipment in forest or wilderness areas particularly susceptible to wildfires. The network described herein would provide early warning and significantly reduce the effects of rapid propagation notorious to wooded and arid natural environments. Also in a preferred embodiment, the electronics equipment is powered by solar cells having a battery back-up. Similarly, border security could be enhanced with video and motion sensing equipment coupled to a network via a coordinator module of the present invention.

In another preferred embodiment to a coordinator module 20 of the present invention, the coordinator module 20 is coupled to a video traffic surveillance and ticketing system. Using wireless concepts described herein, the coordinator module provides remote, real-time transfer of data. Hence, the coordinator module 20 obviates the need to manually retrieve images of traffic intersections. It is further contemplated that providing real-time automation in maintaining imagery of traffic intersections will reduce maintenance overhead thereof. Additionally, the coordinator module 20 could be employed to wirelessly synchronize traffic signals and further to ease traffic congestion in real-time.

In still another preferred embodiment, the coordinator module 20 could be paired with GPS enabled tags and transponders to provide remote tracking of truck fleets, taxi cabs, parcel curriers, and shipping fleets, etc. According to the embodiment, individual trucks could see each other with their own GPS enabled equipment. The solution provided herein is an improvement over current solutions such as OnStar, in that the present invention would not have to rely on a remote website.

In yet another preferred embodiment, the coordinator module 20 could be employed for remote control of UAVs (unmanned aerial vehicles). Presently, command and control of such aircraft comprises pre-determined computerized control with real-time radio control typically limited in distance by line of sight. The present invention contemplates configuring the coordinator 20 with iridium satellite hardware to allow the system herein to connect to a network via satellite.

In an additional preferred embodiment, applicable to law enforcement and military, provides that a coordinator module 20 could be employed to connect various radio communications and electronic equipment. Data therefrom could be incorporated to combat systems programs and/or fire control programs. Feedback from the system will improve situational awareness of all members.

Further to the embodiment applicable to military and law enforcement, a coordinator module 20 is coupled to an armored helmet of the present invention with communications gear inside that further comprises a coordinator module 20. Additionally, the armored helmet of the present invention will include a solid metal face-plate to protect against gunshots and exploding shrapnel; and further comprise multiple cameras 30 providing standard vision as well as thermal vision in 3D. The video from these cameras 30 will be viewable both by the person wearing the helmet as well as by authorized remote parties; and an operating system will allow supporting information to be graphically added to the video, providing an augmented view of reality. The helmet will also be able to receive audio and video from remote cameras, for example, cameras 30 connected to vehicles, UAVs, robots, buildings, other helmets, or on weapons. Of course, because of the coordinator module 20 inside, the helmet will also be able to collect information from a wide variety of sensors, and control various devices remotely. An additional preferred embodiment of the armored helmet of the present invention comprises an amphibious version.

In still an additional preferred embodiment, the coordinator module 20 of the present invention will provide a wireless network that comprises a primary coordinator and various sub-coordinators for command and control of a finite set and sub-sets of devices. A directory tree in the software provided by the present invention will display which devices are coupled to a particular sub-coordinator. The present preferred embodiment contemplates that a user could monitor a variety of sub-applications through a main application. Additional coordinator modules 20 can be added by preference and devices can be added wherein a particular coordinator module 20 is configured to detect the present of a new device and transfer software to the devices as applicable, or as needed. Optionally, the network of coordinators and sub-coordinators 20 could be monitored and controlled through a touch screen having scroll down lists and listed commands.

As an example of general operation and set-up (not necessarily requiring access to a computer), an iPhone, iPad, BlackBerry or other device, detects the presence of a nearby coordinator 20 via Bluetooth or WiFi, and with password authorization, establishes control of that coordinator and its subordinate devices. Alternatively, connection and control could be established through the Internet using any Internet-ready device; or connection and control could be established by an iPhone, BlackBerry, or other smartphone via telephonic connection. In an additional feature contemplated by the present invention, the user experience involved in the connection and control process is simplified through software installed on the control device (e.g. an App for the iPhone). When an iPhone or other control device establishes control of a particular coordinator, additional software may be required to control that coordinator's subordinate devices. In a specific example, the coordinator transfers the required software to the iPhone, or the iPhone could download the required software from the Internet. If a new subordinate device is being assigned to a coordinator, the iPhone or other control device could be used to manage this process.

Other applications would include linking Bluetooth devices to the systems created by the coordinator module. Yet another application would allow a user to remotely control his or her computer with another computer or a mobile phone. Another application contemplates configuring the coordinator with a GPS locator and therefore provides tracking of the system with map downloads.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

While the particular Coordinator Module as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A video server system, comprising:
a coordinator module wherein the coordinator comprises programmable electronics including a flash memory, a processor and a transceiver;
a digital video camera to capture video data and providing digital images; and
a cellular antenna for receiving and transmitting data via a cellular network chosen from the networks known as CDMA and GSM.

2. The video server system of claim 1, wherein the coordinator module further comprises a video archive for retaining captured video data from the digital video camera.

3. The video server system of claim 2, wherein the video archive is remotely accessible to allow for viewing of the captured video data on a mobile device or a computer.

4. The video server system of claim 3, wherein the coordinator module transmits the video data from the video archive as an MMS message to the mobile device.

5. The video server system of claim 1, wherein the coordinator module is remotely controllable by a user using an SMS message from a mobile device to transmit an instruction to the coordinator module.

6. The video server system of claim 1, further comprising low power RF technology chosen from the wireless protocols commonly known as Bluetooth and ZigBee.

7. The video server system of claim 1, wherein the digital video camera is activated by a motion sensor.

8. The video server system of claim 7, wherein the coordinator module transmits an alert to a mobile device in a manner chosen from SMS, MMS or e-mail when the coordinator module is activated by the motion sensor.

9. The video server system of claim 1, the digital video camera further comprising:
a hollowed base portion for supporting the digital video camera;
an upright portion defining a height of the digital camera; and
a camera portion coupled to an upper end of the upright portion, wherein the camera portion together with the hollowed base portion and the upright portion form a “Z” shape in a profile of the digital video camera.

10. A remote monitoring system, comprising:
a metering instrument configured to measure a physical property as measurement data;
a coordinator module wherein the coordinator comprises programmable electronics including a flash memory, a processor and a transceiver, wherein the metering instrument transmits measurement data to the coordinator module;
a cellular antenna for receiving and transmitting data via a cellular network selected from the group of CDMA and GSM.

11. The remote monitoring system of claim 10, wherein the metering instrument further comprises:
an analog-to-digital converter to convert measurement data from an analog signal into a digital signal,
a wireless transmitter to transmit measurement data wirelessly to the coordinator module.

12. The remote monitoring system of claim 10, wherein the coordinator module is remotely controllable by a user using an SMS message from a mobile device to transmit an instruction to the coordinator module.

13. The remote monitoring system of claim 10, wherein the coordinator module transmits an alert chosen from the group of SMS, MMS and e-mail with a message to a mobile device with measurement data from the metering instrument.

14. The remote monitoring system of claim 10, wherein the coordinator module is further configured to perform trip point and calibration checks of the metering instrument.

15. The remote monitoring system of claim 14, wherein the coordinator module transmits an alert chosen from the group of SMS, MMS and e-mail with a message to a mobile device information pertaining to the trip point and calibration checks of the metering instrument.

16. A method of remotely controlling a metering instrument, the method comprising:
providing a metering instrument to measure a physical property as measurement data,
providing a coordinator module wherein the coordinator comprises programmable electronics including a flash memory, a processor and a transceiver, wherein the metering instrument transmits measurement data to the coordinator module; and
providing a cellular antenna for receiving and transmitting data via a cellular network selected from the group of CDMA and GSM.

17. The method of remotely controlling a metering instrument of claim 15, further providing a mobile device configured to receive data via the cellular network in a manner chosen from the group of SMS, MMS or e-mail.

18. The method of remotely controlling a metering instrument of claim 15, further providing a mobile device configured to send data via the cellular network in a manner chosen from the group of SMS, MMS or e-mail to the coordinator module.

19. The method of remotely controlling a metering instrument of claim 17, wherein the coordinator module interprets the data sent from the mobile device to perform an operation on the metering instrument.
